(19) United States
(12) Patent Application Publication
(10) Pub. No.: US 2012/0272759 A1
(43) Pub. Date: Nov. 1, 2012

(54) DEVICE AND METHOD FOR CONVERTING CIRCULAR MOTION

(76) Inventor: Won Tae Kim, Daegu (KR)

(21) Appl. No.: 13/500,751

(22) PCT Filed: Mar. 30, 2010
(86) PCT No.: PCT/KR2010/001950

§ 371 Date: May 30, 2012

(30) Foreign Application Priority Data
Oct. 7, 2009 (KR) 10-2009-0095368

(51) Int. Cl. F16H 37/12

(52) U.S. Cl. 74/53

(57) ABSTRACT

The present invention relates to a device and method for converting circular motion, including: a drive part rotated by a power means; an eccentric cam disposed at one side of the drive part to perform the eccentric rotary motion; a connection rod connected at one side thereof to the eccentric cam in such a manner as to be operated cooperatively along with the motion of the eccentric cam and to perform the linear reciprocating motion, the connection rod being extended forwardly; and motion conversion members rotatably fixed at one sides thereof to a body by means of a hinge shaft and having drive grooves formed thereon in such a manner as to be connectedly fastened to the connection rod to allow the connection rod to be moved along the drive grooves, thereby performing the circular arc motion.

### BACKGROUND OF THE INVENTION

1. Field of the Invention

The present invention relates to a device and method for converting eccentric rotary motion into linear motion and re-converting the linear motion into circular arc motion, wherein the rotary radius of an eccentric cam is greatly utilized to provide the finally amplified circular arc motion, and more particularly, to a device and method for converting eccentric rotary motion into linear motion and re-converting the linear motion into circular arc motion, wherein the rotary radius of an eccentric cam is greatly utilized to allow an amount of circular arc motion of motion conversion members to be greatly amplified, thereby being applicable to various mechanical devices and methods.

2. Background of the Related Art

Typically, a variety of mechanical devices have been developed to convert the direction of rotary motion generated through an eccentric cam operated cooperatively with the rotary power supplied from electricity. That is, a device, to which a method for converting the direction of first motion is applied, usually converts eccentric rotary motion into linear reciprocating motion or circular arc motion.

In the conversion means where the direction of the motion is directly converted into circular arc motion or linear reciprocating motion through the eccentric cam, however, the conversion means itself is under a given resistance, so that the resistance is transmitted just to the eccentric cam converting the direction of motion, thereby increasing the load applied to the eccentric cam and making the efficiency of the driving deteriorated badly.

One of motion direction conversion means using the eccentric cam is disclosed in Korean Patent Registration No. 10-0740602 wherein a device for driving an electric toothbrush capable of performing automatic toothbrushing includes: a housing mounted inside the electric toothbrush; a drive motor mounted at the lower portion of the housing and having terminals formed at the lower end thereof so as to be connected to batteries; a drive gear coupled to a rotary shaft of the drive motor; a power transmission gear rotatably disposed vertically at one side of the housing and interlocked with the drive gear; an eccentric cam formed integrally with the power transmission gear; a link member having a circular arc-shaped curved surface portion formed at the lower end thereof in such a manner as to be interlocked with the eccentric cam; a toothbrush bristle arm coupled to the upper end of the link member and rotated in every direction by means of the rotation of the eccentric cam; and a coil spring interposed between the housing and the toothbrush bristle arm and applying an elastic force to permit the circular arc-shaped curved surface portion of the link member to be always interlocked with the eccentric cam. According to the above-mentioned prior art, the device basically makes use of the conversion of the motion of the link member interlocked with the eccentric cam, that is, a first conversion of the eccentric motion.

As mentioned above, the conventional devices and methods generally perform the first conversion of the direction of the eccentric rotary motion using the eccentric cam, and in this case, if a configuration of the device needs a relatively small force, the conversion method is easily performed. However, if the configuration needs a relatively high horsepower and rotary force and has a substantially large resistance at the time of final driving, load is applied directly to the eccentric cam, thereby undesirably causing many troubles and low efficiency.

So as to enhance the width of the motion generated by final motion members, further, the radius of rotation of the eccentric cam should be increased. In this case, the larger the radius of rotation is, the higher the centrifugal force is at the eccentric cam. As a result, the conventional devices and methods are not applicable to the devices requiring high RPM or having the large width of the motion of the final motion members.

Therefore, there is a definite need for the development of a device and method for converting the rotary motion using the eccentric cam, while applying relatively small load to the eccentric cam and performing the conversion of various motion directions, and especially, for converting eccentric rotary motion into linear motion and re-converting the linear motion into circular arc motion, thereby amplifying the amount of motion finally performed.

### SUMMARY OF THE INVENTION

Accordingly, the present invention has been made in view of the above-mentioned problems occurring in the prior art, and it is an object of the present invention to provide a device and method for converting eccentric rotary motion into linear motion and re-converting the linear motion into circular arc motion that is capable of more efficiently performing the conversion of the direction of the rotary motion of an eccentric cam into the circular arc motion.

It is another object of the present invention to provide a device and method for converting eccentric rotary motion into linear motion and re-converting the linear motion into circular arc motion, so that the circular arc motion is performed having a finally amplified distance even with a small amount of eccentricity, thereby being applicable to devices having high RPM or using a large capacity of power, from which the circular arc motion is generated by using an eccentric cam.

To accomplish the above objects, according to the present invention, there is provided a device for converting eccentric rotary motion into linear motion and re-converting the linear motion into circular arc motion, including: a connection rod adapted to convert the rotary motion of an eccentric cam into linear reciprocating motion; and upper and lower motion conversion members adapted to convert the linear reciprocating motion into the circular arc motion, wherein so as to connect the connection rod with the upper and lower motion conversion members, the upper and lower motion conversion members are fixed at one sides thereof by means of a hinge shaft and have drive grooves lockedly fixed to the connection rod, so that the upper and lower motion conversion members perform the circular arc motion through the movements of the positions of the drive grooves operated cooperatively with the connection rod performing the linear reciprocating motion, the upper and lower motion conversion members being connected to the connection rod in a state where the drive grooves are disposed inside the connection rod and the drive grooves being formed to cross each other or meet each other with a given angle therebetween around a fastening point to the connection rod, thereby allowing the upper and lower motion conversion members to perform the circular arc motion in the opposite directions to each other, along with the linear motion of the connection rod.

According to the present invention, desirably, various changes in the directions of motion and the distance of movements may be made in accordance with the formation directions of the drive grooves and the positions of the shaft.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is an exploded view showing a device for converting eccentric rotary motion into linear motion and re-converting the linear motion into circular arc motion according to the present invention;

FIG. 2 is a plan view showing the device of the present invention;

FIG. 3 is a plan view showing examples of the amplification of the range of motion in the device of the present invention;

FIG. 4 is a plan view showing other examples of the amplification of the range of motion in the device of the present invention;

FIG. 5 is a plan view showing examples of the adjustment of the range of amplified motion in the device of the present invention; and

FIG. 6 is a plan view showing other examples of the adjustment of the range of amplified motion in the device of the present invention.

### DETAILED DESCRIPTION OF THE PREFERRED EMBODIMENT

If rotary power is generated from a typical torque generating means such as an internal combustion engine, a motor and the like, it is transmitted through a mechanical power transmission means such as various gears, cams, shafts and the like and is used to operate various industrial machines. Many of the mechanical devices using the conversion of the direction of the rotary motion perform the conversion through an eccentric cam.

As noted in the conventional practices, the conversion of the direction of the rotary motion through the eccentric cam has been applied to a variety of mechanical devices, and therefore, the devices usually convert a first rotary motion, that is, the eccentric rotary motion, into motion in various directions.

According to the present invention, there is provided a device and method for converting eccentric rotary motion into circular arc motion, thereby enhancing the efficiency and stability in use and being applicable to a variety of mechanical devices. Typically, in case of a power device performing circular arc motion through the conversion of the direction of motion using an eccentric cam, the range of the motion of a means performing the circular arc motion is dependent upon the size of the eccentric cam, and thus, if the diameter of the eccentric cam is increased to enlarge the circular arc motion, a centrifugal force is generated to make it impossible to conduct high speed rotation. In a device requiring high RPM, therefore, if the diameter of the eccentric cam is increased, it is impossible to drive the device. Further, since the eccentric cam is a direct medium for converting the rotary motion into the circular arc motion, load is applied directly to the eccentric cam in accordance with high RPM, the weight of the motion member performing the circular arc motion, and the amount of motion, thereby causing the breakdown and making it hard to provide continuous use. Especially, the increase in the diameter of the eccentric cam is not applicable to a large capacity mechanical device needing large power consumption.

Therefore, the present invention relates to a device and method for amplifying the range of circular arc motion by using the rotary force of an eccentric cam, without any increase in the diameter of the eccentric cam. That is, the directions of motion are changed into the order of eccentric motion (a first motion), linear motion (a second motion), and circular arc motion (a third motion), thereby amplifying the range of the circular arc motion and allowing the amplified circular arc motion to be applied to various mechanical devices.

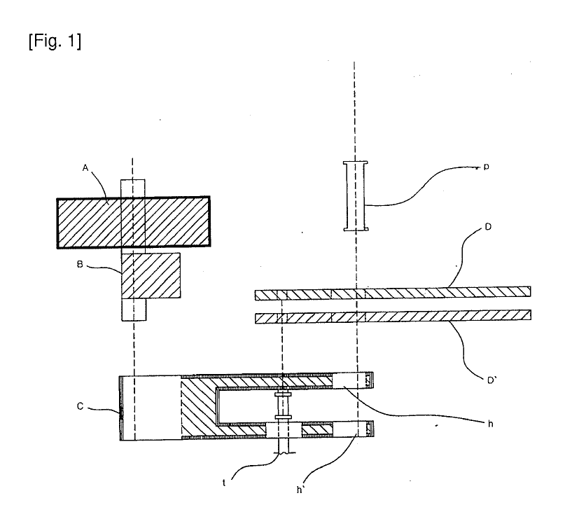

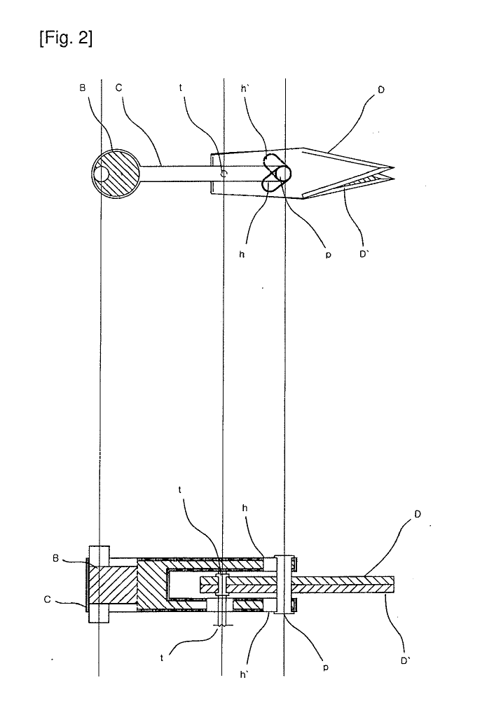

Hereinafter, an explanation on the configuration and operation of the device and method for converting eccentric rotary motion into linear motion and re-converting the linear motion into circular arc motion according to the present invention will be in detail given with reference to the attached drawings. As shown in FIGS. 1 and 2, the rotary motion generated from a rotary power generating means is transmitted to an eccentric cam B connected to one side of a drive part A through the drive part A serving as a motion transmission means such as a shaft, a gear, or the like, thereby allowing the eccentric cam B to perform the eccentric rotary motion (a first eccentric rotary motion). The drive part A is configured in various manners in accordance with the devices and situations to which the drive part is adopted, and in some cases, the eccentric cam B may be connected directly to a shaft of the rotary power generating means.

A connection rod C is connected to one side of the eccentric cam B in such a manner as to be operated cooperatively with the eccentric cam B. The connection rod C performs the linear reciprocating motion (a second linear reciprocating motion) by means of the rotation of the eccentric cam B connected thereto, and if necessary, a guide (not shown) may be disposed to guide the motion of the connection rod C.

As shown in FIGS. 1 and 2, upper and lower motion conversion members D and D′ are connected to one side of the connection rod C so as to perform the circular arc motion, and the upper and lower motion conversion members D and D′ are rotatably at one sides thereof to one side of a body (not shown) by means of a hinge shaft t, while having drive grooves h and h′ formed thereon in such a manner as to be fastened with the connection rod C to allow them to be operated cooperatively with the connection rod C. At this time, the movement of the connection rod C along the drive grooves h and h′ is carried out in such a manner as to have a pair of connection rods disposed on the top and underside of the drive grooves and to fasten the connection rods with the drive grooves by means of a pin, and alternatively, one connection rod is extended to one sides of the tops or undersides of the drive grooves and lockedly connected into the drive grooves by means of a locking means to allow the connection rod to be operated cooperatively with the drive grooves. Like this, a variety of connection means well known in this art may be applicable to the present invention.

Accordingly, the drive grooves h and h′ formed in the motion conversion members D and D′ fixed by means of the hinge shaft t are operated cooperatively with the linear reciprocating motion of the connection rod C, thereby allowing the motion conversion members D and D′ to perform the circular arc motion.

So as to allow the motion conversion members D and D′ to perform the circular arc motion, it is important to determine the formation directions of the drive grooves h and h′. If the drive grooves h and h′ are formed in oblique directions to the direction of the motion of the connection rod C, they are operated cooperatively with the linear reciprocating motion of the connection rod C, thereby permitting the motion conversion members D and D′ to perform the circular arc motion.

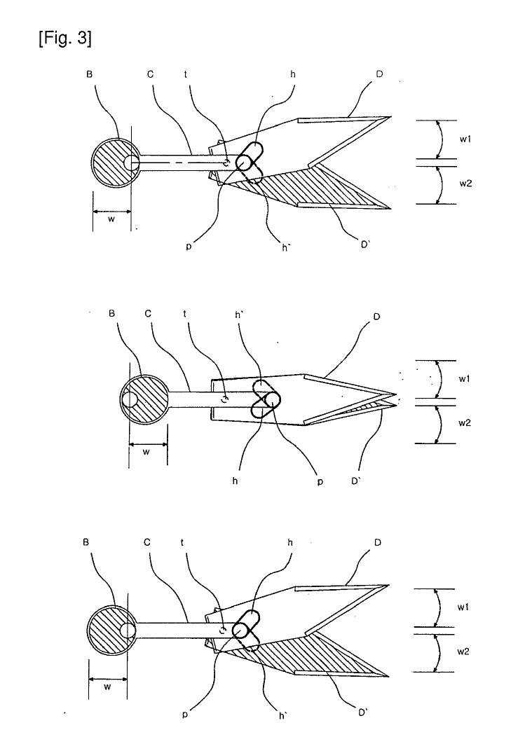

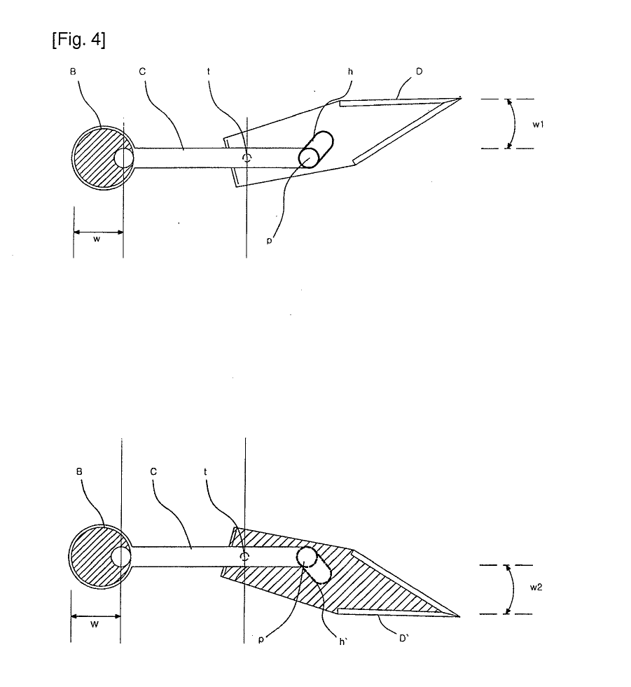

Referring to FIGS. 3 and 4, now, an explanation on the amplification of the range of motion in the above-mentioned basic configuration will be in detail given. In the basic configuration of the present invention, the upper and lower motion conversion members D and D′, which are fixed by means of the hinge shaft t, perform the circular arc motion in accordance with the formation directions of the drive grooves h and h′. Under the above-mentioned principle, if the drive grooves h and h′ are formed in the directions crossing each other, the upper and lower motion conversion members D and D′ perform the circular arc motion in the opposite directions to each other, so that the range of motion can be enlarged to both sides through the rotation of the eccentric cam B having the same diameter, thereby resulting in the amplification of the range of motion. In more detail, the drive grooves h and h′ are formed in oblique directions crossing the direction of the motion of the connection rod C in such a manner as to be connected through the connection rod C, and the connection rod C and the drive grooves h and h′ cross each other or meet each other with a given angle therebetween around a fastening point p. As a result, the drive groove h and h′ of the upper and lower motion conversion members D and D′ are moved along with the linear motion of the connection rod C, and the upper and lower motion conversion members D and D′ perform the circular arc motion in the opposite directions to each other.

It is assumed that the range of the motion generated from one of the upper and lower motion conversion members D and D′ through the drive of the eccentric cam B is W, and thus, if the two motion conversion members D and D′ are used in the same conditions, they move by W in the opposite directions to each other, so that the range of motion is W1+W2, which means the range of motion is amplified two times. Therefore, a substantially large range of motion is formed through the same rotation of the eccentric cam B, which is of course applicable to a variety of mechanical devices.

At this time, the two upper and lower motion conversion members D and D′ are connected through one connection rod C. If necessary, the drive grooves h and h′ of the upper and lower motion conversion members D and D′ may be not overlapped to each other through respective connection rods corresponding thereto, and even in this case, of course, the same motion can be conducted. Under the requirements of motion devices, that is, a plurality of connection rods and the motion conversion members having the respective drive grooves corresponding to the plurality of connection rods may be provided to amplify the range of motion.

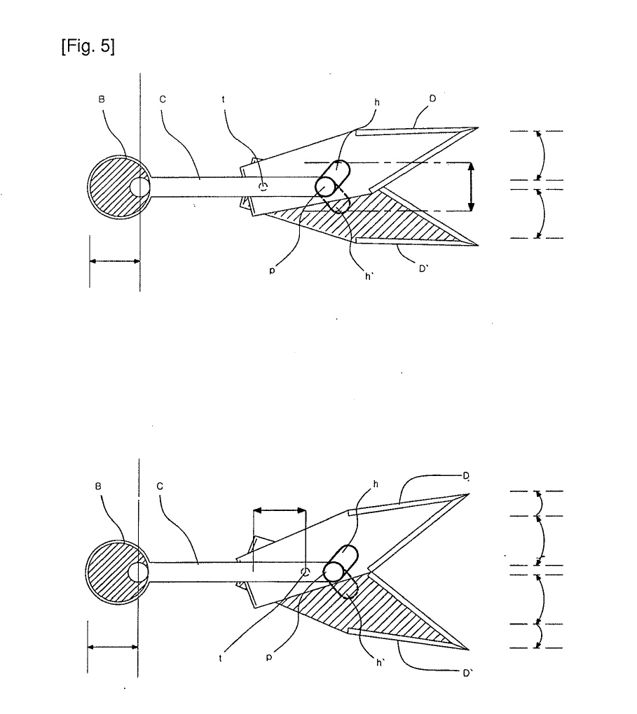

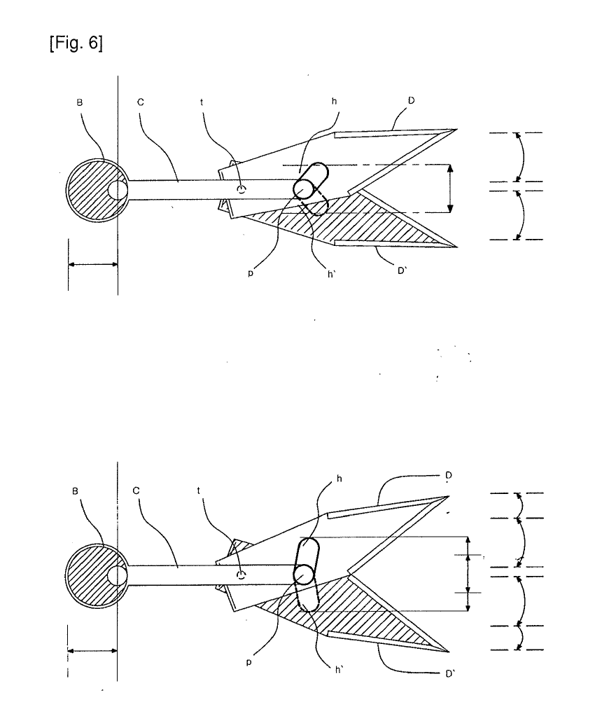

As shown in FIGS. 5 and 6, the widths of the motion amplified are adjusted in various manners, and as mentioned above, the upper and lower motion conversion members D and D′ are fixed at one sides thereof by means of the hinge shaft t and vary the widths of the circular arc motion in accordance with the distance between the hinge shaft t and the fastening point p of the connection rod C to the drive grooves h and h′. As shown in FIG. 5, that is, if the distance between the hinge shaft t and the fastening point p is long on the same conditions, the width of the circular arc motion is relatively small and the load applied to the rotation of the eccentric cam B is also small. Contrarily, if the distance is short, the width of the circular arc motion is relatively large and the load applied to the rotation of the eccentric cam B is also large. As shown in FIG. 6, the ranges of motion may be varied in accordance with the cross angle between the drive grooves h and h′.

As described above, the device and method according to the present invention converts the rotary motion of the eccentric cam into the linear reciprocating motion and re-converts the linear reciprocating motion into the circular arc motion, and in this case, the distance of the circular arc motion is finally amplified by mean of the motion conversion members moving in the opposite directions to each other, so that the device and method of the present invention is applicable efficiently to machines in which large load is applied to the eccentric cam or to machines performing circular arc motion in which the eccentric cam is adopted and a long moving distance is needed. In addition, the present invention solves the problems such as the load applied to the eccentric cam, the breakdown, and the like, in a large capacity drive body, thereby providing the stability in driving and being applicable to a variety of devices performing the circular arc motion in the overall industrial fields.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A device for converting eccentric rotary motion into linear reciprocating motion and re-converting the linear reciprocating motion into circular arc motion, comprising:
a drive part rotated by a power means;
an eccentric cam disposed at one side of the drive part to perform the eccentric rotary motion (a first eccentric rotary motion);
a connection rod connected at one side thereof to the eccentric cam in such a manner as to be operated cooperatively with the eccentric cam and to perform the linear reciprocating motion (a second linear reciprocating motion), the connection rod being extended forwardly; and
motion conversion members overlapped on top of each other, rotatably fixed at one sides thereof to a body by means of a hinge shaft, and having drive grooves formed thereon in such a manner as to be connectedly fastened to the connection rod to allow the connection rod to be moved along the drive grooves, the drive grooves being formed in such a manner as to cross each other, to meet each other, or to be extended with a given angle therebetween around a fastening point to the connection rod, thereby performing the circular arc motion (a third circular arc motion) in the opposite directions to each other along with the linear reciprocating motion of the connection rod.

2. The device according to claim 1, wherein the connection rod operated cooperatively with the eccentric cam is provided plurally in such a manner as to be fastened to the drive grooves of the motion conversion members corresponding thereto.

3. The device according to claim 1, wherein a cross angle of the drive grooves formed in such a manner as to cross each other, meet each other, or to be extended with the given angle therebetween around the fastening point to the connection rod has an interior angle in a range of 0° to 90°.

4. A device for converting eccentric rotary motion into linear reciprocating motion and re-converting the linear reciprocating motion into circular arc motion, comprising:
a drive part rotated by a power means;
an eccentric cam disposed at one side of the drive part to perform the eccentric rotary motion (a first eccentric rotary motion);
a connection rod connected at one side thereof to the eccentric cam in such a manner as to be operated cooperatively with the eccentric cam and to perform the linear reciprocating motion (a second linear reciprocating motion), the connection rod being extended forwardly; and
motion conversion members rotatably fixed at one sides thereof to a body by means of a hinge shaft and having drive grooves formed thereon in such a manner as to be connectedly fastened to the connection rod to allow the connection rod to be moved along the drive grooves, thereby performing the circular arc motion (a third circular arc motion).

5. The device according to claim 1, wherein the drive grooves of the motion conversion members are formed in oblique directions crossing the direction of the motion of the connection rod performing the linear reciprocating motion, thereby allowing the motion conversion members to perform the circular arc motion around the hinge shaft.

6. A method for converting eccentric rotary motion into linear reciprocating motion and re-converting the linear reciprocating motion into circular arc motion, comprising the steps of:
converting the eccentric rotary motion of an eccentric cam generated from a power means into the linear reciprocating motion in the direction of one side performed by means of a connection rod; and
performing the circular arc motion of motion conversion members in the opposite directions to each other along with the linear reciprocating motion of the connection rod, the motion conversion members being overlapped on top of each other, rotatably fixed at one sides thereof to a body by means of a hinge shaft, and having drive grooves formed in such a manner as to cross each other, to meet each other, or to be extended with a given angle therebetween around a fastening point to the connection rod.

7. The method according to claim 6, wherein the connection rod operated cooperatively with the eccentric cam is provided plurally in such a manner as to be fastened to the drive grooves of the motion conversion members corresponding thereto.

8. The method according to claim 6, wherein a cross angle between the drive grooves of the motion conversion members is varied to adjust the width of the circular arc motion.

9. A method for converting eccentric rotary motion into linear reciprocating motion and re-converting the linear reciprocating motion into circular arc motion, comprising the steps of:
converting the eccentric rotary motion of an eccentric cam generated from a power means into the linear reciprocating motion in the direction of one side performed by means of a connection rod; and
converting the linear reciprocating motion of the connection rod into the circular arc motion of motion conversion members, the motion conversion members being rotatably fixed at one sides thereof by means of a hinge shaft and having drive grooves formed thereon.

10. The device according to claim 6, wherein the distance between the hinge shaft of the motion conversion members and the drive grooves is varied to adjust the width of the circular arc motion.

11. The device according to claim 2, wherein a cross angle of the drive grooves formed in such a manner as to cross each other, meet each other, or to be extended with the given angle therebetween around the fastening point to the connection rod has an interior angle in a range of 0° to 90°.

12. The device according to claim 4, wherein the drive grooves of the motion conversion members are formed in oblique directions crossing the direction of the motion of the connection rod performing the linear reciprocating motion, thereby allowing the motion conversion members to perform the circular arc motion around the hinge shaft.

13. The device according to claim 9, wherein the distance between the hinge shaft of the motion conversion members and the drive grooves is varied to adjust the width of the circular arc motion.
